(19) United States
(12) Patent Application Publication
(10) Pub. No.: US 2015/0125117 A1
(43) Pub. Date: May 7, 2015

(54) FIBER OPTIC MOUNTING ARRANGEMENT AND METHOD OF COUPLING OPTICAL FIBER TO A TUBULAR

(71) Applicants: Carl W. Stoesz, Blacksburg, VA (US); Douglas J. Murray, Blacksburg, VA (US); David O. Craig, Spring, TX (US)

(72) Inventors: Carl W. Stoesz, Blacksburg, VA (US); Douglas J. Murray, Blacksburg, VA (US); David O. Craig, Spring, TX (US)

(73) Assignee: BAKER HUGHES INCORPORATED, Houston, TX (US)

(21) Appl. No.: 14/073,395

(22) Filed: Nov. 6, 2013

(51) Int. Cl. G02B 6/38

(52) U.S. Cl. CPC G02B 6/3801
USPC 385/51

(57) ABSTRACT

A method of coupling optical fiber to a tubular includes positioning at least one optical fiber at least partially within an annular cavity defined between a tubular and an elongated member and radially compressing the elongated member against the tubular.

### BACKGROUND

Typical systems for coupling optical fiber to a tubular for purposes of sensing parameters such as strain, temperature, pressure, acoustic energy of the tubular include adhesively bonding the optical fiber to the tubular. Positioning the adhesive, typically an epoxy, into continuous contact between the optical fiber and the tubular has proven difficult. Some systems rely on pumping an epoxy into the tubular after the optical fiber has been placed therewithin. Pumping epoxy has limitation of length through which the epoxy can be effectively pumped. The industry is therefore always receptive to new arrangements and methods to overcome the foregoing and other limitations with conventional systems.

### BRIEF DESCRIPTION

Disclosed herein is a method of coupling optical fiber to a tubular. The method includes positioning at least one optical fiber at least partially within an annular cavity defined between a tubular and an elongated member and radially compressing the elongated member against the tubular.

Further disclosed herein is a fiber optic mounting arrangement. The arrangement includes a tubular, an elongated member positioned within the tubular, at least one optical fiber at least partially positioned between the tubular and the elongated member and the at least one optical fiber is parameter transmissively mounted to the tubular.

### BRIEF DESCRIPTION OF THE DRAWINGS

The following descriptions should not be considered limiting in any way. With reference to the accompanying drawings, like elements are numbered alike:

FIG. 1 depicts a cross sectional view of a fiber optic mounting arrangement disclosed herein in a non-parameter transmissively mounted position;

FIG. 2 depicts a cross sectional view of the fiber optic mounting arrangement of FIG. 1 in a parameter transmissively mounted position;

FIG. 3 depicts a cross sectional view of an alternate embodiment of a fiber optic mounting arrangement disclosed herein;

FIG. 4 depicts a cross sectional view of an alternate embodiment of a fiber optic mounting arrangement disclosed herein; and

FIG. 5 depicts a cross sectional view of an alternate embodiment of a fiber optic mounting arrangement disclosed herein.

### DETAILED DESCRIPTION

A detailed description of one or more embodiments of the disclosed apparatus and method are presented herein by way of exemplification and not limitation with reference to the Figures.

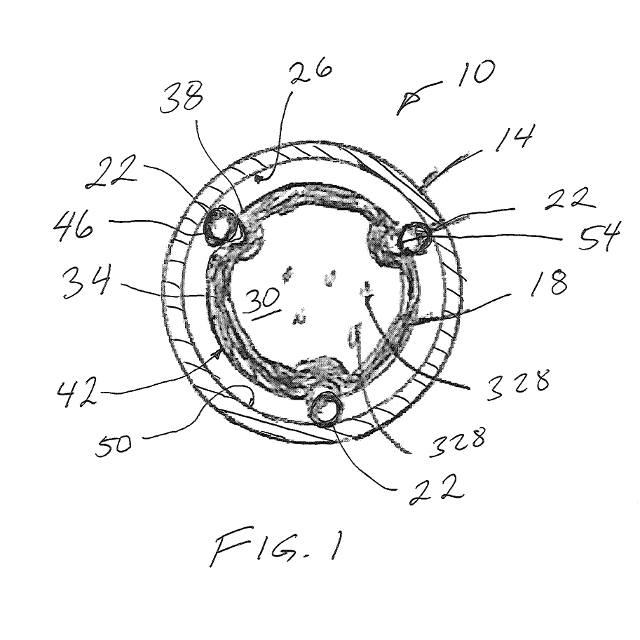

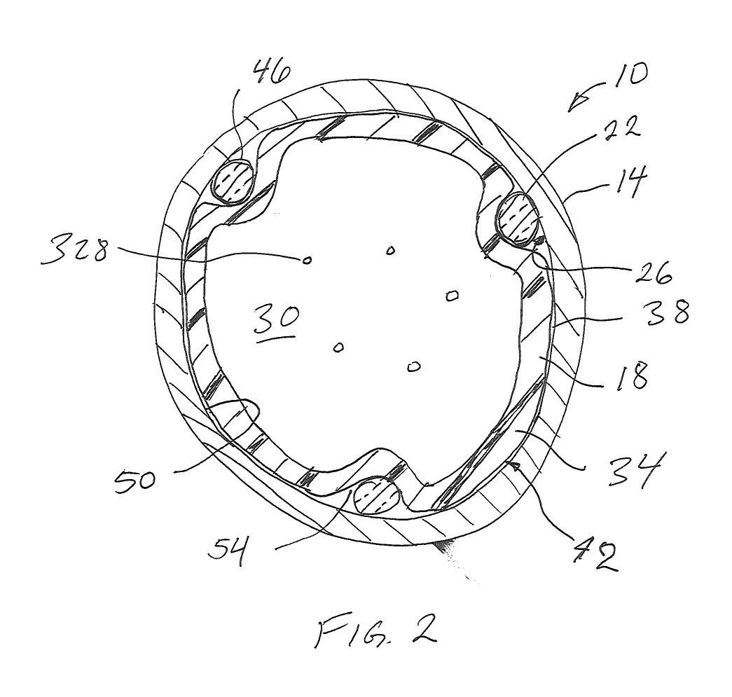

Referring to FIGS. 1 and 2, cross sectional views of a fiber optic mounting arrangement disclosed herein is illustrated at 10 in a non-parameter transmissively mounted position in FIG. 1 and a parameter transmissively mounted position in FIG. 2. The arrangement 10 includes a tubular 14, an elongated member 18, and at least one optical fiber 22, with three of the optical fibers 22 being illustrated in this embodiment, that are parameter transmissively mounted to the tubular 14. As such, parameters encountered by the tubular 14 are sensed by the optical fibers 22. These parameters include but are not limited to strain, temperature, pressure and acoustic energy. Such a mounting is also sometimes referred to as being strain-locked since movement of the tubular 14 in response to strain therein is also exhibited in and therefore sensed by the optical fiber 22 attached therealong. Both the elongated member 18 and the optical fibers 22 are positioned within the tubular 14 and extend longitudinally therewithin. The optical fibers 22 are compressed radially between an inner surface 26 of the tubular 14 and the elongated member 18. The coupling of the optical fibers 22 to the tubular 14 may be due to the radially compressive forces alone, due to adhesion of the optical fibers 22 to one or both of the elongated member 18 and the tubular 14, or combinations of any of the foregoing.

The radial compression can be in response to radial expansion of the elongated member 18, for example. Radial expansion of the elongated member 18 in this embodiment is in response to pressure applied to an inside 30 of the elongated member 18 that causes the walls 34 of the elongated member 18 to be “blown” radially outwardly. Heating of the elongated member 18 can facilitate the radial expansion thereof by partially melting and thereby softening the walls 34. This softening can also aid in adhering the elongated member 18 to one or both of the tubular 14 and the optical fibers 22. In so doing, an adhesive 38 specifically for adhering the elongated member 18 to one or both of the tubular 14 and the optical fibers 22 is optional.

While this embodiment is directed to radially expanding the elongated member 18 with pressure applied therewithin, other embodiments are contemplated. For example, the tubular 14 could be a form of heat shrinkable tubing such that heat alone causes the tubular 14 to shrink radially. Alternately, the elongated member 18 can be configured to radially expand in response to being heated to essentially work inversely to that of heat-shrink tubing.

Heating of the elongated member 18 can be accomplished indirectly by heating of the tubular 14 that in turn heats the elongated member 18 or by more direct means, including heating the elongated member 18 prior to it being positioned within the tubular 14 or heating the elongated member 18 after positioning it within the tubular by heated fluid that is pumped therethrough, for example. The elongated member 18 can also be heated by electrical induction through the tubular 14.

Optionally, adhesion of the elongated member 18 to the optical fibers 22 can be facilitated by cladding the optical fibers 22 with the same or similar material that forms at least an outer surface 42 of the elongated member 18. In so doing, cladding 46 of the optical fibers 22 can essentially be welded to at least the surface 42 of the elongated member 18. Similarly, at least the inner surface 26 of the tubular 14 can be made of or coated with an optional material 50 of the same or similar material that forms the outer surface 42 of the elongated member 18 to allow welding to take place between the outer surface 42 and the material 50. Additionally, the optical fibers 22 can be adhered directly to the inner surface 26 as well, including through welding of the cladding 46 to the material 50. This adhesion, without the use of additional materials beyond those of the optical fiber 22, the tubular 14 and the elongated members 18 themselves, can improve energy transmissibility between the tubular 14 and the optical fiber 22 and improve thermal response time over system that employ separate adhesive materials.

Making the elongated member 18, the cladding 46 and the material 50, if used, out of a polymer may make the process of boding them together easier since lower temperatures can typically be employed to soften them in comparison to use of a material such as metal were employed instead. Metal, however, may be desirable for use as the tubular 14 for other reasons other than facilitating bonding, and is fully compatible with embodiments disclosed herein.

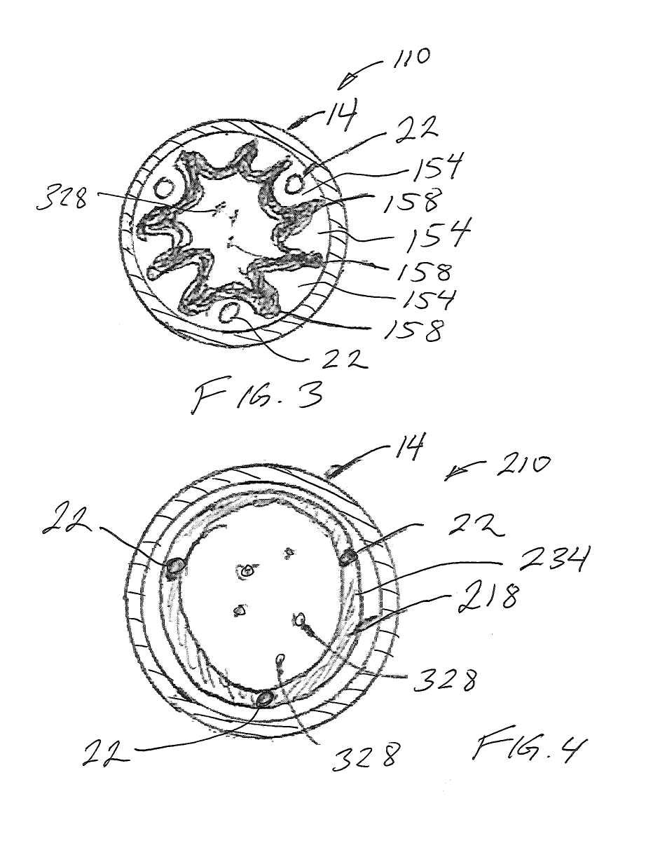

Referring to FIG. 3, an alternate embodiment of a fiber optic mounting arrangement disclosed herein is illustrated in cross section at 110. The arrangement 110 primarily differs from the arrangement 10 in the cross sectional shape of an elongated member 118 in comparison to that of the elongated member 18. Wherein the elongated member 18 includes optional grooves 54 for at least temporarily aligning the optical fibers 22 relative to the elongated member 18, the elongated member 118 includes a plurality of grooves 154 that essentially cover the full perimeter of the elongated member 118. The grooves 154 make it nearly impossible for an optical fiber 22 to not be aligned with at least one of the grooves 154, and further allow an operator to select various numbers of the optical fibers 22 depending upon each applications particular need. The grooves 154 of the illustrated embodiment define protrusions 158 between each pair of adjacent grooves 154. The grooves 154 and the protrusions 158 can be sized relative to the optical fibers 22 to accommodate radial compression of the optical fibers 22 and adhesion of the protrusions 158 to the inner surface 26 at selectable levels of radial expansion of the elongated member 118.

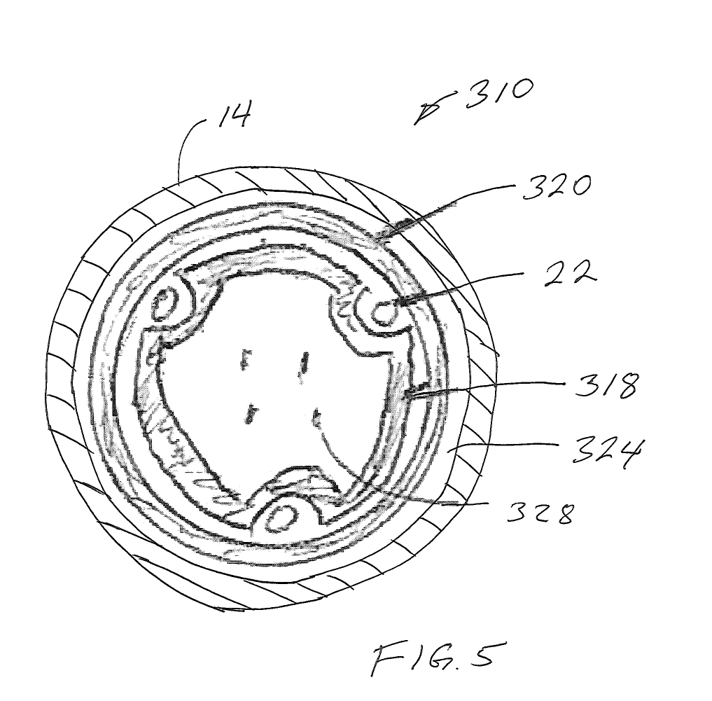

Referring to FIG. 4, an alternative embodiment of a fiber optic mounting arrangement is illustrated in cross section at 210 in a non-parameter transmissively mounted or non-radially compressed position. The arrangement 210 differs from the arrangements 10 and 110 primarily in that the optical fibers 22 in the arrangement 210 are embedded in walls 234 of an elongated member 218 instead of positioned radially thereof or within grooves. A portion of the optical fibers 22 can extend radially beyond an outer surface 42 of the elongated member 218 such that they are pressed against the inner surface 26 or can be contained completely within the walls 234. Positioning the optical fibers 22 within the walls 234 while the elongated member 238 is being extruded is one possible process for forming this embodiment. Regardless of how the optical fiber 22 is positioned within the walls 234, the optical fibers 22 can be loose within the walls until radial compression of the elongated member 238 occurs, or can be fixed to the elongated member 238 prior to expansion thereof. In this, as in the other embodiments, the tubular 14 can be formed by rolling and seam welding flattened metal around the optical fibers 22, the elongated member 18, 118, 218, 318, and the sleeve 320 (if one is used) in a continuous process, as can be the heating, radially altering and the adhering.

Referring to FIG. 5, yet another alternate embodiment of a fiber optic mounting arrangement is illustrated in cross section at 310 in a non-radially expanded position. The arrangement 310 is similar to the arrangement 10 however with an addition of a sleeve 320 positioned in the annular space 324 defined between the tubular 14 and the elongated member 318. In this embodiment the sleeve 320 is positioned radially outwardly of the optical fibers 22. In this embodiment not only are the optical fibers 22 parameter transmissively mounted to one or both of the elongated member 318 and the sleeve 320 but the sleeve 320 is also parameter transmissively mounted to the tubular 14. The methods of creating radial compression and/or adhesion between the optical fibers 22, the elongated member 318, the sleeve 320 and the tubular 14 are similar to those described in relation to the previous embodiments and as such will not be listed again hereunder.

Each of the embodiments illustrated employ three of the optical fibers 22, although more or fewer of the optical fibers 22 can be employed in other embodiments. Using a plurality of the optical fibers 22 allows the arrangements 10, 110, 210 and 310 disclosed to provide differential strain information experienced between one side of the elongated member 18 and another side. Embodiments that employ fewer of the optical fibers 22, including possibly just a single one of the optical fibers 22 can provide similar sensing as to those with multiple fibers by twisting the optical fibers 22 in a helical fashion around the elongated member 18, 118, 218 and 318, for example. Such a configuration could be created by wrapping the optical fiber(s) 22 around the elongated member or by twisting the elongated member 18 after the optical fiber(s) 22 are positioned relative to the outer surface 42, such as within the grooves 54, 154, for example.

Additionally, the elongated members 18, 118, 218, 318 can be solid or can be hollow (as shown in the embodiments illustrated). Hollow embodiments, allow for transporting fluid or pressure therethrough as well as running conduits 328 such as electrical conductors, other optical fibers or hollow tubes, therethrough.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method of coupling optical fiber to a tubular, comprising:
positioning at least one optical fiber at least partially within an annular cavity defined between a tubular and an elongated member; and
radially compressing the elongated member against the tubular.

2. The method of coupling optical fiber to a tubular of claim 1, further comprising heating the elongated member.

3. The method of coupling optical fiber to a tubular of claim 1, further comprising adhering the elongated member to the tubular.

4. The method of coupling optical fiber to a tubular of claim 1, further comprising adhering the at least one optical fiber to the elongated member.

5. The method of coupling optical fiber to a tubular of claim 1, further comprising building pressure within the elongated member.

6. The method of coupling optical fiber to a tubular of claim 1, further comprising radially compressing the optical fiber between the elongated member and the tubular.

7. The method of coupling optical fiber to a tubular of claim 1, further comprising coupling the at least one optical fiber to the elongated member.

8. The method of coupling optical fiber to a tubular of claim 1, further comprising radially expanding the elongated member.

9. The method of coupling optical fiber to a tubular of claim 1, further comprising twisting the at least one optical fiber around the elongated member.

10. The method of coupling optical fiber to a tubular of claim 1, further comprising twisting the elongated member and the at least one optical fiber.

11. The method of coupling optical fiber to a tubular of claim 1, further comprising melting the elongated member.

12. The method of coupling optical fiber to a tubular of claim 1, further comprising melting at least a portion or a cladding of the at least one optical fiber.

13. The method of coupling optical fiber to a tubular of claim 1, further comprising heating the tubular.

14. The method of coupling optical fiber to a tubular of claim 1, further comprising forming at least one groove longitudinally in the elongated member and positioning the at least one optical fiber within the at least one groove.

15. The method of coupling optical fiber to a tubular of claim 1, further comprising embedding the at least one optical fiber within a wall of the elongated member and fixing the at least one optical fiber to the elongated member prior to radially compressing the elongated member against the tubular.

16. The method of coupling optical fiber to a tubular of claim 1, wherein the coupling optical fiber to the tubular is a continuous process.

17. The method of coupling optical fiber to a tubular of claim 1, further comprising positioning a sleeve in the annular space between the elongated member and the at least one optical fiber.

18. The method of coupling optical fiber to a tubular of claim 1, further comprising positioning a plurality of the at least one optical fibers with substantially equal perimetrical distances therebetween.

19. The method of coupling optical fiber to a tubular of claim 1, further comprising positioning auxiliary fibers within the elongated member.

20. The method of coupling optical fiber to a tubular of claim 1, further comprising adhering the elongated member to the tubular without material separate from that of the elongated member or the tubular.

21. The method of coupling optical fiber to a tubular of claim 1, further comprising transmitting parameters exhibited in the tubular to the at least one optical fiber.

22. A fiber optic mounting arrangement comprising:
a tubular;
an elongated member positioned within the tubular;
at least one optical fiber at least partially positioned between the tubular and the elongated member; and
the at least one optical fiber being parameter transmissively mounted to the tubular.

23. The fiber optic mounting arrangement of claim 22, wherein the elongated member is adhered to an inner radial surface of the tubular.

24. The fiber optic mounting arrangement of claim 22, wherein the optical fiber is positioned within an annular space defined between the elongated member and an inner radial surface of the tubular.

25. The fiber optic mounting arrangement of claim 22, wherein the tubular is metallic and the elongated member is polymeric.

26. The fiber optic mounting arrangement of claim 22, wherein the at least one optical fiber is in the shape of a helix.

27. The fiber optic mounting arrangement of claim 22, wherein the elongated member radially expands when heated.

28. The fiber optic mounting arrangement of claim 22, further comprising a sleeve positioned in the annular space between the tubular and the elongated member.

29. The fiber optic mounting arrangement of claim 22, wherein the at least one optical fiber is radially compressed between the elongated member and the tubular.

30. The fiber optic mounting arrangement of claim 22, wherein parameters transmissive from the tubular to the at least one optical fiber include one or more from the group consisting of strain, temperature, pressure and acoustic energy.
